(19) United States
(12) Patent Application Publication
(10) Pub. No.: US 2006/0064915 A1
(43) Pub. Date: Mar. 30, 2006

(54) Decoy for attracting a game animal

(76) Inventor: Ralph J. Cianciarulo, Lanark, IL (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/954,848

(22) Filed: Sep. 30, 2004

(51) Int. Cl. A01M 31/06

(52) U.S. Cl. 43/2

(57) ABSTRACT

A decoy for attracting a game animal includes a body portion having a height, a width, and a length. The height and width are similar to those of a body of the game animal and the length is substantially reduced from that of the body of the game animal, such that the body portion resembles the body of the game animal when viewed only from the front and back. A three-dimension head portion that resembles the head of the game animal when viewed from all sides is attached to the body portion, such that the decoy at least partially resembles the game animal to be attracted when viewed from any side.

### BACKGROUND OF THE INVENTION

The present invention relates generally to a decoy for attracting a game animal, and more particularly, to a decoy for attracting deer.

Decoys for attracting game animals are generally well-known. Typically, hunters use decoys when hunting to help attract the game animals being hunted within range of the hunters' bows and arrows and/or firearms. Hunters typically travel into the woods or other hunting area, oftentimes relatively great distances and usually by foot, in order to find an appropriate hunting spot. When using a decoy, the hunter must, therefore, carry the decoy to the hunting spot, along with all other gear and supplies necessary for hunting.

Because hunters typically have to transport the decoys into the hunting area by foot, it is essential that the decoy be of relatively light weight and be relatively easy to transport. However, it is also essential that the decoy be capable of effectively attracting game animals, such as deer. Completely three-dimensional decoys are generally known but are big, bulky, and difficult to transport. Completely two-dimensional decoys are also generally known and are easier to transport than three-dimensional decoys, but attract game animals less effectively than three-dimensional decoys because two-dimensional decoys do not resemble an actual game animal from all angles.

It would therefore be desirable to have a decoy that is lighter and easier to carry than a completely three-dimensional decoy, while attracting deer more effectively than a completely two-dimensional decoy.

### BRIEF SUMMARY OF THE INVENTION

Briefly stated, in one aspect, the present invention is a decoy for attracting a game animal. The game animal includes a head and a body having a height, length, and width. The decoy includes a body portion having a height measured from a top to a bottom of the body portion, a width measured from a left side to a right side of the body portion, and a length measured from a front to a back of the body portion. The height and width are similar to those of the body of the game animal, and the length is substantially reduced from that of the body of the game animal, such that the body portion resembles the body of the game animal when viewed only from the front and back. The decoy further includes a three-dimensional head portion that resembles the game animal when viewed from all sides. The head portion is attached to the body portion, such that the decoy at least partially resembles the game animal to be attracted when viewed from any side.

In another aspect, the present invention is a decoy includes a body portion that is substantially compressed in one dimension, such that the body portion is substantially two-dimensional. A three-dimensional head portion is attached to the body portion, wherein the decoy at least partially resembles an animal from any angle.

In another aspect, the present invention is a deer decoy including a lengthwise-compressed body portion that is anatomically correct when viewed from a front and a back and is anatomically incorrect when viewed from left and right sides. A three-dimensional head portion is attached to the body portion. The head portion is anatomically correct when viewed from any side.

In another aspect, the present invention is a decoy for attracting a game animal including a body portion. A head portion is attached to the body portion. At least one ear is removably attached to the head portion.

### BRIEF DESCRIPTION OF THE SEVERAL VIEWS OF THE DRAWINGS

The foregoing summary, as well as the following detailed description of the preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a left rear perspective view of a decoy in accordance with a preferred embodiment of the present invention;

FIG. 2 is a rear elevational view of the decoy of FIG. 1;

FIG. 3 is a left side elevational view of the decoy of FIG. 1; and

FIG. 4 is a partially exploded view of the decoy of FIG. 1.

### DETAILED DESCRIPTION OF THE INVENTION

Certain terminology is used in the following description for convenience only and is not limiting. The words “right,” “left,” “upper,” and “lower” designate directions in the drawings to which reference is made. The terminology includes the words above specifically mentioned, derivatives thereof, and words of similar import.

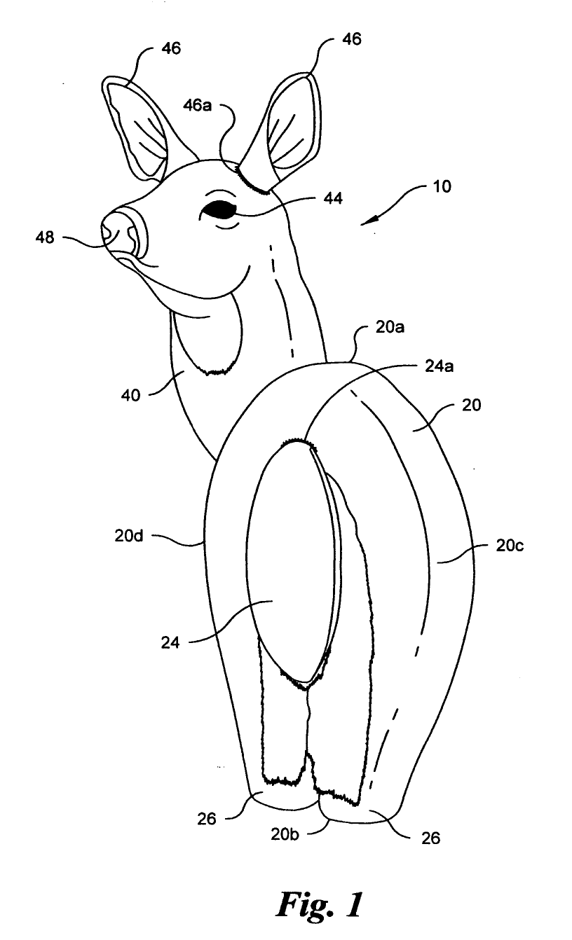

Referring to the drawings in detail, wherein like numerals indicate like elements throughout, there is shown in FIGS. 1-4 a decoy, indicated generally at 10, having a body portion 20 and a head portion 40 attached thereto, in accordance with the present invention. The decoy 10 is intended to be used for attracting a game animal, such as a deer (not shown). The game animal generally includes a head (not shown) and a body (not shown) generally having a height, length, and width.

Referring to FIGS. 1-3, the body portion 20 has a height measured from a top 20a to a bottom 20b, a width measured from a left side 20c to a right side 20d, and a length measured from a front 20e to a rear 20f. The body portion 20 is substantially compressed in one dimension, such that the body portion 20 is substantially two-dimensional. Preferably, the body portion 20 is compressed in a lengthwise direction so that the body portion 20 is anatomically correct when viewed from the front and the back and is generally anatomically incorrect when viewed from the left and right sides. That is, the height and width of the body portion 20 are preferably similar to those of the body of the game animal, and the length is substantially reduced from that of the body of the game animal. In this way, the body portion 20 resembles the body of the game animal when viewed only from the front and back. Although it is preferred that the length of the body portion 20 be compressed, it is within the spirit and scope of the present invention that one of the width and height be compressed instead, with the length and the other one of the width and height being generally anatomically correct provided the decoy 10 still functions as described herein.

The head portion 40 is generally three-dimensional and is attached to the body portion 20. The head portion 40 resembles the head of the game animal when viewed from all sides. That is, the head portion 40 is generally anatomically correct when viewed from any side. In this way, when the head portion 40 is attached to the body portion 20, the decoy 10 at least partially resembles the game animal to be attracted when viewed from any side.

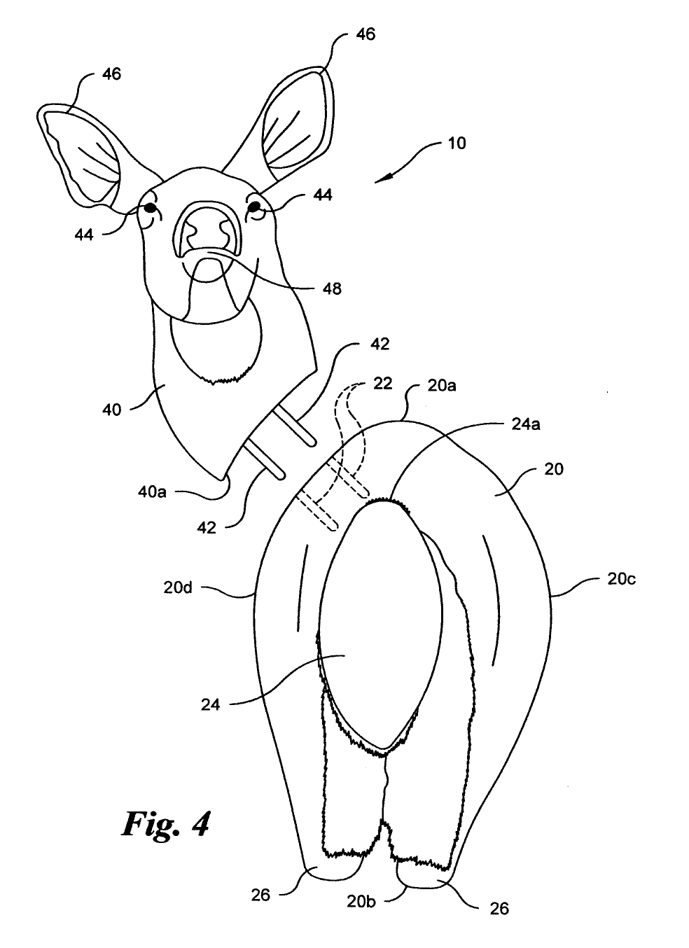

Referring to FIG. 4, the head portion 40 is preferably removeably attached to the body portion 20. The head portion 40 includes at least one tab 42 extending outwardly from proximate a bottom 40a of the head portion 40. The body portion 20 includes at least one corresponding slot 22 therein proximate the top 20a of the body portion 20. The at least one tab 42 is slidably inserted within the at least one slot 22 to attach the head portion 40 to the body portion 20. Preferably, there are two tabs or rods 42 extending from the bottom 40a of the head portion 40, which are insertable within two corresponding slots or holes 22 within the body portion 20. Although this is preferred, it is within the spirit and scope of the present invention that there be more or less than two rods 42 and slots 22 or that the rods 42 extend from the body portion 20 and the holes 22 be disposed within the head portion 40. It is preferred that the rods 42 and slots 22 are dovetail-shaped, although it is within the spirit and scope of the present invention that the rods 42 and slots 22 could take other shapes, such as circular, square, triangular, or ovular, for instance, provided that the alternatively shaped rods 42 and slots 22 are capable of functioning to retain the head portion 40 on the body portion 20. It is further within the spirit and scope of the present invention that the head portion 40 be attached to the body portion 20 using an attachment method other than the above-described tab-in-slot method, such as pinning, using Velcro, taping, or the like. It is also contemplated that the head portion 40 be integrally formed with the body portion 20, such that there is a permanent connection therebetween.

Referring again to FIGS. 1-3, the head portion 40 and the body portion 20 are preferably formed to resemble the head and body of a deer, so that, when assembled, the decoy 10 resembles a deer from any angle. Although it is preferred that the decoy 10 be formed to resemble a deer, it is within the spirit and scope of the present invention that the decoy 10 be formed to resemble any game animal, including, but not limited to, elk, antelope, moose, turkeys, bears, lions, and the like.

Specifically, the head portion 40 has an outwardly protruding nose/snout 48, upwardly extending ears 46, and eyes 44 disposed within the head portion 40, which are fashioned to resemble those features of an actual deer. Additionally, removable antlers (not shown) can be used with the head portion 40 if it is desired that the decoy 10 resemble a buck or removed if it is desired that the decoy 10 resemble a doe.

The rear 20f of the body portion 20 is preferably formed to resemble the back end of the body of a deer. To that end, the body portion 20 preferably has a tail 24 disposed on the rear 20f thereof. Preferably, legs 26 are disposed at the bottom 20b of the body portion 20 to further enhance the resemblance of the decoy 10 to an actual deer. To decrease the weight of the decoy 10 and enhance its portability, it is preferred that the legs 26 be partial representations of the legs of an actual deer, in that only the upper part of the leg is represented. Although this is preferred, it is within the spirit and scope of the present invention that the legs 26 represent the full length of the legs of an actual deer.

The front 20e of the body portion 20 is preferably generally flattened and formed to resemble the front of the body of a deer. That is, the front 20e is preferably generally plain and smooth with no ridges or other detail. Although this is preferred, it is within the spirit and scope of the present invention that the front 20e incorporate ridges and detail as long as the decoy 10 is still able to function as described herein. For instance, it is contemplated that the front 20e of the decoy 10 be formed similarly to the rear 20f, such that both the front 20e and the rear 20f have tails 24 and similar markings. In this way, the decoy 10 would resemble the back of an actual deer when viewed from both the front and the back.

The body portion 20 is preferably decorated to resemble the markings of the body of an actual deer. Specifically, the front 20e and the rear 20f of the body portion 20 are preferably brown with a white patch generally at the center of the rear 20f, stretching from below the top 20a to just above the bottom 20b, such that the tail 24 partially covers the white patch of the rear 20f. Although it is preferred that the body portion 20 is decorated in this way, it is within the spirit and scope of the present invention that the body portion 20 be decorated in another way, provided the decoy 10 is able to function to attract game animals such as deer.

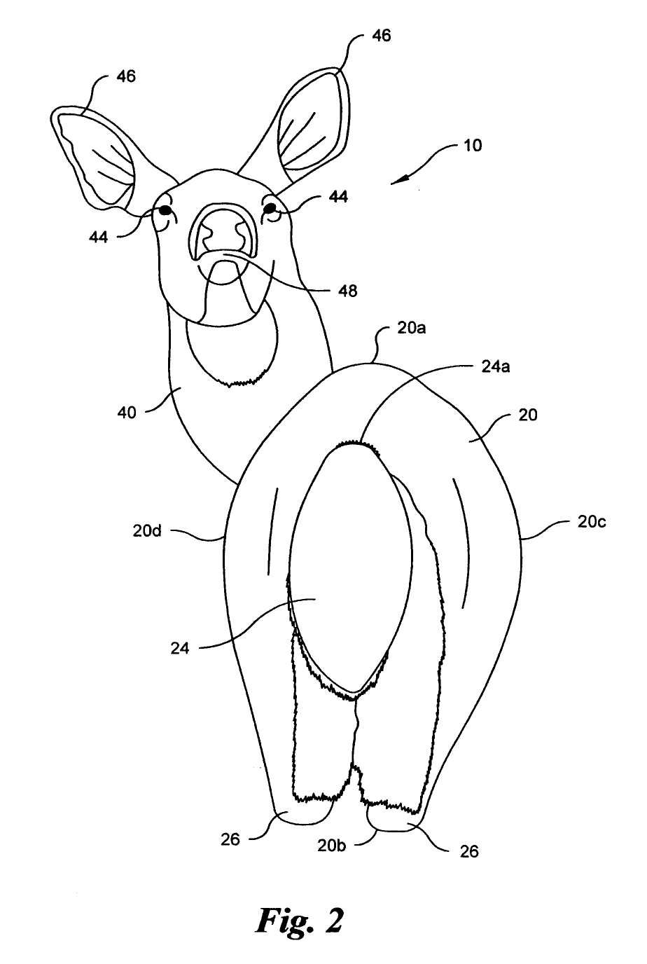

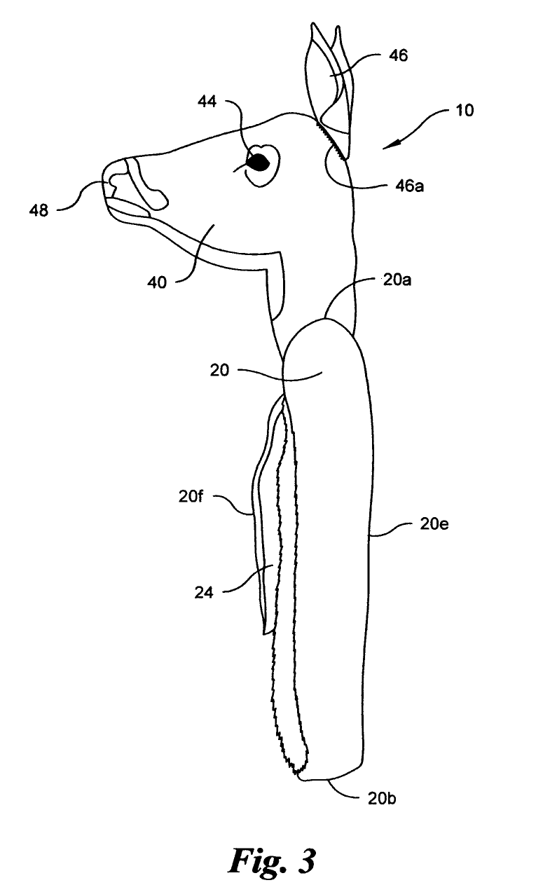

Referring to FIGS. 2 and 3, when the decoy 10 is assembled, the head portion 40 preferably faces rearwardly, such that, when viewing the rear 20f of the body portion 20, the front of the head portion 40 can be seen. Although this is preferable, it is within the spirit and scope of the present invention that the head portion 40 face forwardly or sidewardly when attached to the body portion 20.

Preferably, both the head portion 40 and the body portion 20 are made out of a foam, which is then painted to resemble the markings of a deer. Preferably, the foam used for the decoy 10 is polystyrene or molded polyethylene foam, although it is within the spirit and scope of the present invention that another lightweight foam be used, such as polyurethane or high or low density polyethylene foam, for instance.

There are several advantages to forming the decoy 10 from foam including, but not limited to, the following. First, by making the decoy 10 out of foam, the decoy 10 is lightweight and relatively easily portable. Second, foam does not hold scent like at least some fabrics and stuffings, so an actual deer is less likely to pick up the human scent from the decoy 10. Third, because the head portion 40 and the body portion 20 of the decoy 10 are each made of solid pieces of foam, the decoy 10 makes very little noise when being transported through the woods or other hunting area to help prevent the deer to be hunted from being alerted to the presence of the hunter. Fourth, foam is essentially non-absorbent, thereby enabling the decoy 10 to be exposed to rain and dew without becoming waterlogged. Lastly, foam does not reflect light as do other materials from which a decoy could be made, thereby making the decoy 10 more lifelike in appearance. Although it is preferable that the decoy 10 be made out of foam, it is within the spirit and scope of the present invention that the decoy 10 be made of a substance other than foam as long as the decoy 10 remains lightweight and portable as well as effective in attracting deer or other game animals.

Preferably, the eyes 44 disposed in the head portion 40 are made of glass. By using glass eyes 44, the eyes 44 reflect light and further enhance the lifelike appearance of the decoy 10. Although it is preferred to use glass eyes 44, it is within the spirit and scope of the present invention that another substance, such as plastic, be used to make the eyes 44 or that the eyes be made out of foam like the rest of the head portion 40.

To further enhance the lifelike appearance of the decoy 10, the tail 24 and ears 46 attached to the body portion 20 and the head portion 40, respectively, are preferably moveable with respect to the rest of the decoy 10. This is accomplished by either making the ears 46 and the tail 24 out of a flexible material such as a fabric like felt or polar fleece, for instance. Although a flexible material is preferred, it is within the spirit and scope of the present invention that the ears 46 and tail 24 be formed out of foam and painted similarly to the head portion 40 and the body portion 20. Preferably, the ears 46 and/or the tail 24 are removably attached to the head and body portions 40, 20, respectively, using Velcro 46a, 24a or other similar attachment methods. When attached to the decoy 10 in this way, the ears 46 and the tail 24 are able to be moved by wind blowing by the decoy 10. Alternatively, the ears 46 and the tail 24 can be attached to the decoy 10 using a spring connection (not shown) to allow the ears 46 and the tail 24 to wobble and/or flicker when blown by the wind or a pivotable connection (not shown) to allow the ears 46 and the tail 24 to pivot slightly when blown by the wind. Although it is preferable that the ears 46 and the tail 24 be made out of felt, polar fleece, or foam, it is within the spirit and scope of the present invention that other materials be used to make the ears 46 and the tail 24 as long as those materials are lightweight and non-absorbent so that the ears 46 and the tail 24 do not absorb water or dew while in use. Additionally, although it is preferable that the ears 46 and the tail 24 be moved when blown by the wind, it is within the spirit and scope of the present invention that the ears 46 and the tail 24 be motorized to enable movement thereof even in the absence of wind.

Although not portrayed in the figures, it is within the spirit and scope of the present invention that the body portion 20 have a hole therethrough, extending from the front 20e to the rear 20f. The hole would allow wind to blow through the decoy 10 to facilitate the moving of the tail 24 by the wind. Also, the hole could be used to position the nose 48 therein when the decoy 10 is disassembled to further facilitate packing and carrying of the decoy 10, for instance.

The decoy 10 can be set up in the woods or other hunting area by positioning the decoy 10 on one or more plastic or metal stakes (not shown), which are then driven into the ground so that the decoy 10 is able to stand on its own. The one or more stakes can have a spring (not shown) associated therewith to allow the decoy 10 to wobble or otherwise move slightly, thereby further enhancing the lifelike appearance of the decoy 10. Alternatively, the decoy 10 can be tied to or propped against a tree, bush, fence, frame, or the like. It is also possible to hang the decoy 10 from a tree using ropes (not shown), string (not shown), or the like.

In use, the hunter carries the decoy 10 into the woods or other hunting area. When an appropriate hunting location is found, the decoy 10 is assembled by attaching the head portion 40 to the body portion 20. The decoy 10 is secured in an upright position so that it is able to be seen by the deer to be attracted. The hunter can then hide and wait for deer to be attracted by the decoy 10 within range of the hunter.

In this way, the decoy 10 of the present invention provides a lightweight and relatively easily portable decoy for attracting deer. Because the body portion 20 is lengthwise-compressed and generally two-dimensional, the decoy 10 is relatively easy to handle and carry, enabling a hunter to relatively easily transport the decoy 10 into the woods or other hunting area to a particular hunting location therein. Additionally, because the head portion 40 of the decoy 10 is generally three-dimensional and generally anatomically correct, the decoy 10, when assembled, resembles a deer or other game animal from any angle, thereby enhancing the effectiveness of the decoy 10 in attracting deer. As stated above, the decoy 10 can be formed to resemble game animals other than deer, and, as such, benefits similar to those stated above hold true for the decoy 10 regardless of the game animal it is designed to resemble.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention.

1. A decoy for attracting a game animal, the game animal including a head and a body having a height, length, and width, the decoy comprising:
a body portion having a height measured from a top to a bottom of the body portion, a width measured from a left side to a right side of the body portion, and a length measured from a front to a back of the body portion, the height and width being similar to those of the body of the game animal and the length being substantially reduced from that of the body of the game animal, such that the body portion resembles the body of the game animal when viewed only from the front and back; and
a three-dimensional head portion that resembles the head of the game animal when viewed from all sides, the head portion being attached to the body portion, such that the decoy at least partially resembles the game animal to be attracted when viewed from any side.

2. The decoy of claim 1, wherein the head portion is removably attached to the body portion.

3. The decoy of claim 2, wherein the head portion includes at least one tab extending outwardly from proximate a bottom of the head portion and the body portion includes at least one slot therein proximate the top of the body portion, the at least one tab being inserted within the at least one slot to attach the head portion to the body portion.

4. The decoy of claim 1, wherein the decoy resembles a deer.

5. The decoy of claim 1, further comprising at least one ear removably attached to the head portion.

6. The decoy of claim 5, wherein the at least one ear is made of a flexible material to allow movement thereof when blown by wind.

7. The decoy of claim 1, further comprising at least one tail removably attached to the body portion.

8. The decoy of claim 7, wherein the at least one tail is made of a flexible material to allow movement thereof when blown by wind.

9. A decoy, comprising:
a body portion that is substantially compressed in one dimension, such that the body portion is substantially two-dimensional; and
a three-dimensional head portion attached to the body portion, wherein the decoy at least partially resembles an animal from any angle.

10. The decoy of claim 9, wherein the body portion includes a slot therein and the head portion includes a tab extending outwardly wherefrom, the tab being insertable within the slot to removably attach the head portion to the body portion.

11. The decoy of claim 9, wherein the head portion and the body portion are formed to resemble a deer.

12. The decoy of claim 9, further comprising at least one ear removably attached to the head portion.

13. The decoy of claim 12, wherein the at least one ear is made of a flexible material to allow movement thereof when blown by wind.

14. The decoy of claim 9, further comprising at least one tail removably attached to the body portion.

15. The decoy of claim 14, wherein the at least one tail is made of a flexible material to allow movement thereof when blown by wind.

16. A deer decoy, comprising:
a lengthwise-compressed body portion that is anatomically correct when viewed from a front and a back and is anatomically incorrect when viewed from left and right sides; and
a three-dimensional head portion attached to the body portion, the head portion being anatomically correct when viewed from any side.

17. The deer decoy of claim 16, wherein the head portion is removably attached to the body portion.

18. The deer decoy of claim 17, wherein the head portion includes at least one tab extending outwardly from proximate a bottom of the head portion and the body portion includes at least one slot therein proximate a top of the body portion, the at least one tab being inserted within the at least one slot to attach the head portion to the body portion.

19. The deer decoy of claim 16, further comprising at least one ear removably attached to the head portion.

20. The deer decoy of claim 19, wherein the at least one ear is made of a flexible material to allow movement thereof when blown by wind.

21. The decoy of claim 16, further comprising at least one tail removably attached to the body portion.

22. The deer decoy of claim 21, wherein the at least one tail is made of a flexible material to allow movement thereof when blown by wind.

23. A decoy for attracting a game animal, comprising:
a body portion;
a head portion attached to the body portion; and
at least one ear removably attached to the head portion, wherein the at least one ear is made of a flexible material to allow movement thereof when blown by wind.

24. (canceled)

25. The decoy of claim 23, further comprising at least one tail removably attached to the body portion.

26. The decoy of claim 25, wherein the at least one tail is made of a flexible material to allow movement thereof when blown by wind.

27. A decoy for attracting a game animal comprising:
a body portion;
a head portion attached to the body portion, the head portion being removably attached to the body portion, the head portion including at least one tab extending outwardly from proximate a bottom of the head portion and the body portion including at least one slot therein proximate a top of the body portion, the at least one tab being inserted within the at least one slot to attach the head portion to the body portion; and
at least one ear removably attached to the head portion.

28. The decoy of claim 23, wherein the body portion is substantially compressed in one dimension, such that the body portion is substantially two-dimensional, and the head portion is three-dimensional, such that, when the head portion is attached to the body portion, the decoy at least partially resembles an animal from any angle.

29. The decoy of claim 23, wherein the decoy resembles a deer.
